(19) United States
(12) Patent Application Publication
(10) Pub. No.: US 2021/0012233 A1
(43) Pub. Date: Jan. 14, 2021

(54) ADAPTIVE COMPILATION OF QUANTUM COMPUTING JOBS

(71) Applicant: International Business Machines Corporation, Armonk, NY (US)

(72) Inventors: Jay M. Gambetta, Yorktown Heights, NY (US); Ismael Faro Sertage, Chappaqua, NY (US); Ali Javadiabhari, Sleepy Hollow, NY (US); Francisco Jose Martin Fernandez, Chappaqua, NY (US); Paul Nation, Yorktown Heights, NY (US)

(21) Appl. No.: 16/508,887

(22) Filed: Jul. 11, 2019

(51) Int. Cl. G06N 10/00; G06F 8/41

(52) U.S. Cl. CPC G06N 10/00; G06F 8/445

(57) ABSTRACT

Systems, computer-implemented methods, and computer program products to facilitate adaptive compilation of quantum computing jobs are provided. According to an embodiment, a system can comprise a memory that stores computer executable components and a processor that executes the computer executable components stored in the memory. The computer executable components can comprise a selection component that selects a quantum device to execute a quantum program based on one or more run criteria. The computer executable components can further comprise an adaptive compilation component that modifies the quantum program based on one or more attributes of the quantum device to generate a modified quantum program compilation of the quantum program.

### BACKGROUND

The subject disclosure relates to compilation of quantum computing jobs, and more specifically, to adaptive compilation of quantum computing jobs.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, computer-implemented methods, and/or computer program products that facilitate adaptive compilation of quantum computing jobs are described.

According to an embodiment, a system can comprise a memory that stores computer executable components and a processor that executes the computer executable components stored in the memory. The computer executable components can comprise a selection component that selects a quantum device to execute a quantum program based on one or more run criteria. The computer executable components can further comprise an adaptive compilation component that modifies the quantum program based on one or more attributes of the quantum device to generate a modified quantum program compilation of the quantum program.

According to an embodiment, a computer-implemented method can comprise selecting, by a system operatively coupled to a processor, a quantum device to execute a quantum program based on one or more run criteria. The computer-implemented method can further comprise modifying, by the system, the quantum program based on one or more attributes of the quantum device to generate a modified quantum program compilation of the quantum program.

According to an embodiment, a computer program product that can facilitate an adaptive compilation of quantum computing jobs process is provided. The computer program product can comprise a computer readable storage medium having program instructions embodied therewith, the program instructions can be executable by a processing component to cause the processing component to select, by the processor, a quantum device to execute a quantum program based on one or more run criteria. The program instructions can also cause the processing component to modify, by the processor, the quantum program based on one or more attributes of the quantum device to generate a modified quantum program compilation of the quantum program.

### DESCRIPTION OF THE DRAWINGS

FIG. 1 illustrates a block diagram of an example, non-limiting system that can facilitate adaptive compilation of quantum computing jobs in accordance with one or more embodiments described herein.

FIG. 2 illustrates a block diagram of an example, non-limiting system that can facilitate adaptive compilation of quantum computing jobs in accordance with one or more embodiments described herein.

FIG. 3 illustrates a block diagram of an example, non-limiting system that can facilitate adaptive compilation of quantum computing jobs in accordance with one or more embodiments described herein.

FIG. 4 illustrates a block diagram of an example, non-limiting system that can facilitate adaptive compilation of quantum computing jobs in accordance with one or more embodiments described herein.

FIG. 5 illustrates a diagram of an example, non-limiting system that can facilitate adaptive compilation of quantum computing jobs in accordance with one or more embodiments described herein.

FIG. 6 illustrates a flow diagram of an example, non-limiting computer-implemented method that can facilitate adaptive compilation of quantum computing jobs in accordance with one or more embodiments described herein.

FIG. 7 illustrates a flow diagram of an example, non-limiting computer-implemented method that can facilitate adaptive compilation of quantum computing jobs in accordance with one or more embodiments described herein.

FIG. 8 illustrates a block diagram of an example, non-limiting operating environment in which one or more embodiments described herein can be facilitated.

FIG. 9 illustrates a block diagram of an example, non-limiting cloud computing environment in accordance with one or more embodiments of the subject disclosure.

FIG. 10 illustrates a block diagram of example, non-limiting abstraction model layers in accordance with one or more embodiments of the subject disclosure.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Quantum computing is generally the use of quantum-mechanical phenomena for the purpose of performing computing and information processing functions. Quantum computing can be viewed in contrast to classical computing, which generally operates on binary values with transistors. That is, while classical computers can operate on bit values that are either 0 or 1, quantum computers operate on quantum bits (qubits) that comprise superpositions of both 0 and 1, can entangle multiple quantum bits, and use interference.

Quantum computing has the potential to solve problems that, due to their computational complexity, cannot be solved, either at all or for all practical purposes, on a classical computer. However, quantum computing requires very specialized skills to, for example, program quantum computing jobs, where such quantum computing jobs can be executed by a quantum computing device (e.g., a quantum computer, quantum processor, etc.) based on a compilation (e.g., via a compiler, transpiler, etc.) of quantum programs.

Quantum programming is the process of assembling sequences of instructions, called quantum programs, that are capable of running on a quantum computer. Each quantum program can have a collection of quantum circuits. Currently, there are few real quantum computers in the world available to run quantum programs. So, running an execution in a quantum computer is very exclusive. Therefore, running on a quantum computer is similar to running on a high-performance computing (HPC) device, since there are more requests of quantum programs to run than devices available to execute them.

A problem with existing technologies is that they do not provide a queue type communication between all the quantum programs to be run and the quantum computers available. Another problem with existing technologies is that they do not enable analysis of all quantum programs waiting to be executed on a quantum computer and modification of one or more of such quantum programs to facilitate dispatching a certain quantum program to a certain quantum computer at a particular moment in time (e.g., to the next available quantum computer, to the least utilized quantum computer, to the quantum computer having the best fidelity, etc.).

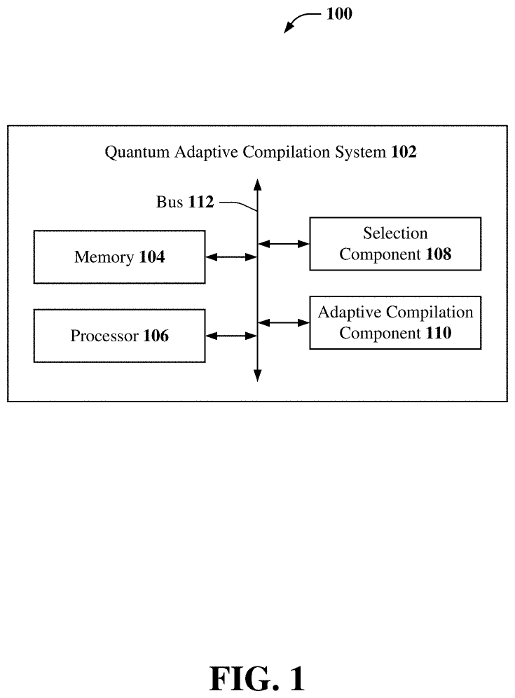

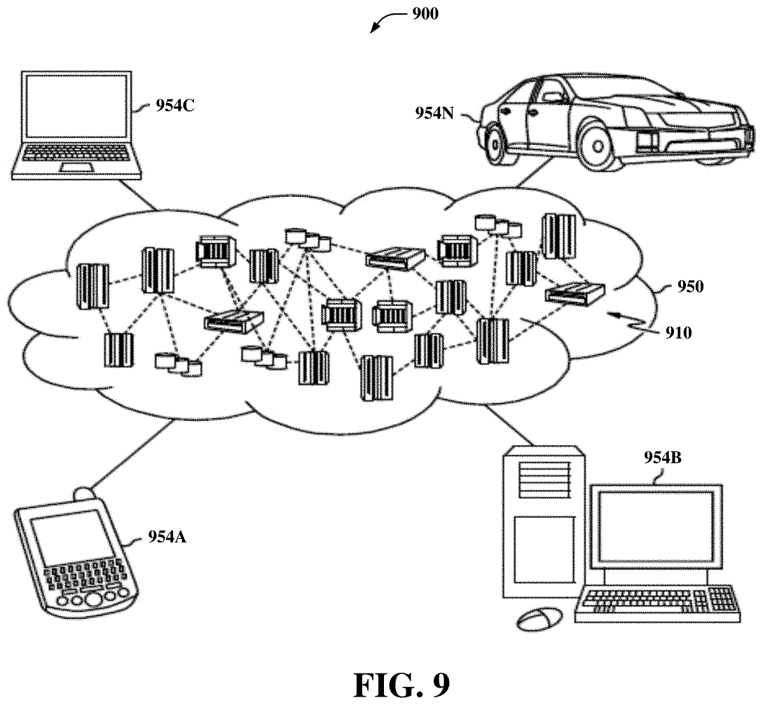

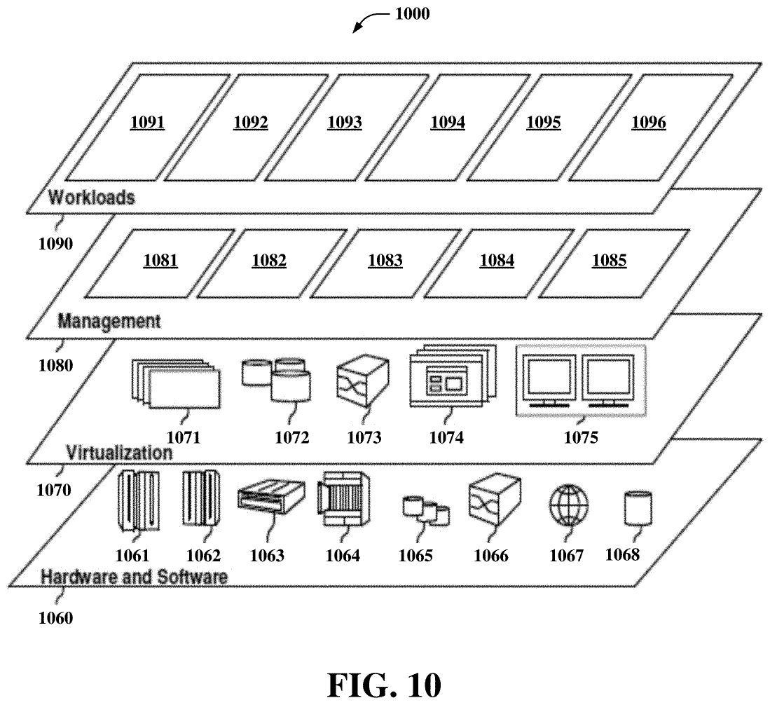

FIG. 1 illustrates a block diagram of an example, non-limiting system 100 that can facilitate adaptive compilation of quantum computing jobs in accordance with one or more embodiments described herein. In some embodiments, system 100 can comprise a quantum adaptive compilation system 102, which can be associated with a cloud computing environment. For example, quantum adaptive compilation system 102 can be associated with cloud computing environment 950 described below with reference to FIG. 9 and/or one or more functional abstraction layers described below with reference to FIG. 10 (e.g., hardware and software layer 1060, virtualization layer 1070, management layer 1080, and/or workloads layer 1090).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Continuing now with FIG. 1, according to several embodiments, system 100 can comprise a quantum adaptive compilation system 102. In some embodiments, quantum adaptive compilation system 102 can comprise a memory 104, a processor 106, a selection component 108, an adaptive compilation component 110, and/or a bus 112.

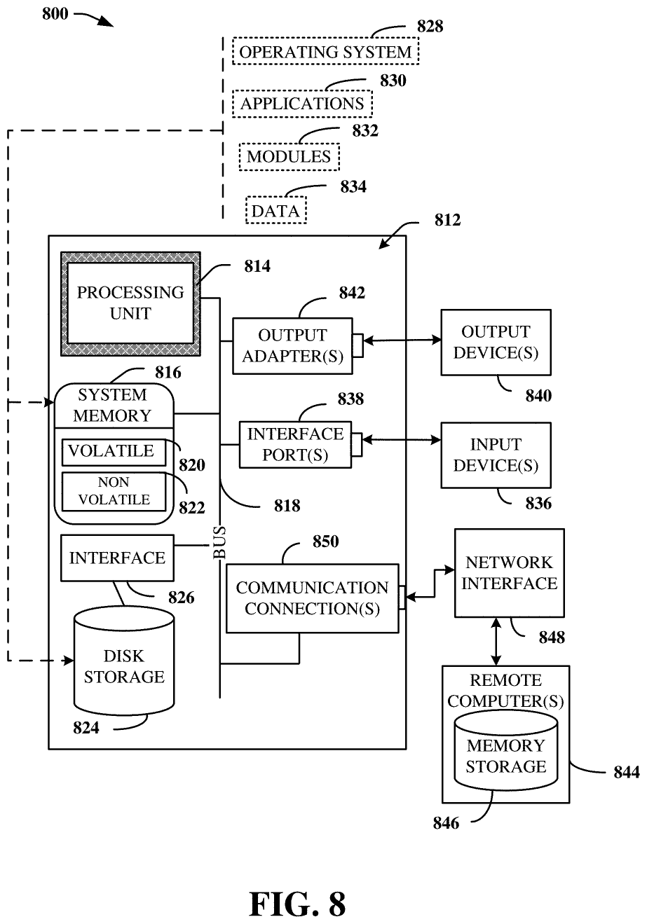

It should be appreciated that the embodiments of the subject disclosure depicted in various figures disclosed herein are for illustration only, and as such, the architecture of such embodiments are not limited to the systems, devices, and/or components depicted therein. For example, in some embodiments, system 100 and/or quantum adaptive compilation system 102 can further comprise various computer and/or computing-based elements described herein with reference to operating environment 800 and FIG. 8. In several embodiments, such computer and/or computing-based elements can be used in connection with implementing one or more of the systems, devices, components, and/or computer-implemented operations shown and described in connection with FIG. 1 or other figures disclosed herein.

According to multiple embodiments, memory 104 can store one or more computer and/or machine readable, writable, and/or executable components and/or instructions that, when executed by processor 106, can facilitate performance of operations defined by the executable component(s) and/or instruction(s). For example, memory 104 can store computer and/or machine readable, writable, and/or executable components and/or instructions that, when executed by processor 106, can facilitate execution of the various functions described herein relating to quantum adaptive compilation system 102, selection component 108, adaptive compilation component 110, and/or another component associated with quantum adaptive compilation system 102 (e.g., scheduler component 202, interface component 302, quantum device(s) 402, etc.), as described herein with or without reference to the various figures of the subject disclosure.

In some embodiments, memory 104 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 104 are described below with reference to system memory 816 and FIG. 8. Such examples of memory 104 can be employed to implement any embodiments of the subject disclosure.

According to multiple embodiments, processor 106 can comprise one or more types of processors and/or electronic circuitry that can implement one or more computer and/or machine readable, writable, and/or executable components and/or instructions that can be stored on memory 104. For example, processor 106 can perform various operations that can be specified by such computer and/or machine readable, writable, and/or executable components and/or instructions including, but not limited to, logic, control, input/output (I/O), arithmetic, and/or the like. In some embodiments, processor 106 can comprise one or more central processing unit, multi-core processor, microprocessor, dual microprocessors, microcontroller, System on a Chip (SOC), array processor, vector processor, and/or another type of processor. Further examples of processor 106 are described below with reference to processing unit 814 and FIG. 8. Such examples of processor 106 can be employed to implement any embodiments of the subject disclosure.

In some embodiments, quantum adaptive compilation system 102, memory 104, processor 106, selection component 108, adaptive compilation component 110, and/or another component of quantum adaptive compilation system 102 as described herein can be communicatively, electrically, and/or operatively coupled to one another via a bus 112 to perform functions of system 100, quantum adaptive compilation system 102, and/or any components coupled therewith. In several embodiments, bus 112 can comprise one or more memory bus, memory controller, peripheral bus, external bus, local bus, and/or another type of bus that can employ various bus architectures. Further examples of bus 112 are described below with reference to system bus 818 and FIG. 8. Such examples of bus 112 can be employed to implement any embodiments of the subject disclosure.

According to multiple embodiments, quantum adaptive compilation system 102 can comprise any type of component, machine, device, facility, apparatus, and/or instrument that comprises a processor and/or can be capable of effective and/or operative communication with a wired and/or wireless network. All such embodiments are envisioned. For example, quantum adaptive compilation system 102 can comprise a server device, a computing device, a general-purpose computer, a special-purpose computer, a quantum computing device (e.g., a quantum computer), a tablet computing device, a handheld device, a server class computing machine and/or database, a laptop computer, a notebook computer, a desktop computer, a cell phone, a smart phone, a consumer appliance and/or instrumentation, an industrial and/or commercial device, a digital assistant, a multimedia Internet enabled phone, a multimedia players, and/or another type of device.

In some embodiments, quantum adaptive compilation system 102 can be coupled (e.g., communicatively, electrically, operatively, etc.) to one or more external systems, sources, and/or devices (e.g., computing devices, communication devices, etc.) via a data cable (e.g., High-Definition Multimedia Interface (HDMI), recommended standard (RS) 232, Ethernet cable, etc.). In some embodiments, quantum adaptive compilation system 102 can be coupled (e.g., communicatively, electrically, operatively, etc.) to one or more external systems, sources, and/or devices (e.g., computing devices, communication devices, etc.) via a network.

According to multiple embodiments, such a network can comprise wired and wireless networks, including, but not limited to, a cellular network, a wide area network (WAN) (e.g., the Internet) or a local area network (LAN). For example, quantum adaptive compilation system 102 can communicate with one or more external systems, sources, and/or devices, for instance, computing devices (and vice versa) using virtually any desired wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols. In such an example, quantum adaptive compilation system 102 can thus include hardware (e.g., a central processing unit (CPU), a transceiver, a decoder), software (e.g., a set of threads, a set of processes, software in execution) or a combination of hardware and software that facilitates communicating information between quantum adaptive compilation system 102 and external systems, sources, and/or devices (e.g., computing devices, communication devices, etc.).

In some embodiments, quantum adaptive compilation system 102 can comprise one or more computer and/or machine readable, writable, and/or executable components and/or instructions that, when executed by processor 106, can facilitate performance of operations defined by such component(s) and/or instruction(s). Further, in numerous embodiments, any component associated with quantum adaptive compilation system 102, as described herein with or without reference to the various figures of the subject disclosure, can comprise one or more computer and/or machine readable, writable, and/or executable components and/or instructions that, when executed by processor 106, can facilitate performance of operations defined by such component(s) and/or instruction(s). For example, selection component 108, adaptive compilation component 110, and/or any other components associated with quantum adaptive compilation system 102 as disclosed herein (e.g., communicatively, electronically, and/or operatively coupled with and/or employed by quantum adaptive compilation system 102), can comprise such computer and/or machine readable, writable, and/or executable component(s) and/or instruction(s). Consequently, according to numerous embodiments, quantum adaptive compilation system 102 and/or any components associated therewith as disclosed herein, can employ processor 106 to execute such computer and/or machine readable, writable, and/or executable component(s) and/or instruction(s) to facilitate performance of one or more operations described herein with reference to quantum adaptive compilation system 102 and/or any such components associated therewith.

In some embodiments, quantum adaptive compilation system 102 can facilitate performance of operations executed by and/or associated with selection component 108, adaptive compilation component 110, and/or another component associated with quantum adaptive compilation system 102 as disclosed herein (e.g., scheduler component 202, interface component 302, quantum device(s) 402, etc.). For example, as described in detail below, quantum adaptive compilation system 102 can facilitate (e.g., via processor 106): selecting a quantum device to execute a quantum program based on one or more run criteria; and/or modifying the quantum program based on one or more attributes of the quantum device to generate a modified quantum program compilation of the quantum program. In some embodiments, the one or more run criteria are selected from a group consisting of: availability of the quantum device; access to the quantum device; workload of the quantum device; fidelity of the quantum device; complexity of the quantum program; anticipated execution time corresponding to the quantum program; entity software entitlement; entity preference; and/or entity defined pulse schedule. In some embodiments, the one or more attributes of the quantum device are selected from a group consisting of a configuration of the quantum device and/or a property of the quantum device.

In some embodiments, quantum adaptive compilation system 102 can further facilitate (e.g., via processor 106): dispatching the modified quantum program compilation to a queue of the quantum device to execute the modified quantum program compilation; dispatching the modified quantum program compilation to a queue of the quantum device to execute the modified quantum program compilation based on a run order position of the modified quantum program compilation in the queue of the quantum device; determining a run order position of the modified quantum program compilation in a queue of the quantum device based on the one or more run criteria; and/or modifying at least one of a quantum circuit of the quantum program or a pulse schedule of the quantum program.

According to multiple embodiments, selection component 108 can select a quantum device to execute a quantum program based on one or more run criteria. For example, selection component 108 can select a quantum device (e.g., quantum computer, quantum processor, quantum simulator, etc.) to execute a quantum program based on one or more run criteria (e.g., quantum-based run criteria) including, but not limited to: availability of the quantum device; access to the quantum device (e.g., user rights and/or user privileges enabling access to the quantum device by an entity requesting execution of the quantum program); workload of the quantum device; fidelity of the quantum device (e.g., fidelity of one or more qubits of the quantum device, accuracy of the results generated by the quantum device, etc.); complexity of the quantum program (e.g., complexity of one or more circuits of the quantum program, etc.); anticipated execution time corresponding to the quantum program; entity software entitlement (e.g., user rights and/or user privileges such as, for instance, software licenses enabling access to quantum-based and/or classical software to execute the quantum program); entity preference (e.g., preference of shorter execution time and potentially less accurate results, preference of longer execution time and potentially more accurate results, etc.); entity defined pulse schedule; and/or another run criterion. In some embodiments, selection component 108 can select a quantum device to execute a quantum program based on such one or more run criteria defined above where such a quantum device can include, but is not limited to, a quantum computer, a quantum processor, a quantum simulator, and/or another quantum device.

In some embodiments, selection component 108 can select the next available quantum device. For example, selection component 108 can select the next iteration of an available quantum device.

In some embodiments, selection component 108 can select a quantum device that is accessible by, for instance, an entity (e.g., a programmer, a device, a computer, a robot, a machine, an artificial intelligence driven module, a human, etc.) that submitted the quantum program to quantum adaptive compilation system 102, where such accessibility by such an entity can be based on user rights and/or user privileges of the entity that allow the entity to access to the quantum device (e.g., access to quantum computer, quantum processor, etc.). In some embodiments, selection component 108 can select the quantum device having the smallest workload relative to other quantum device candidates (e.g., the least busy quantum device).

In some embodiments, selection component 108 can select a quantum device based on a defined level of fidelity (e.g., defined by an entity such as, for instance, a programmer, a device, a computer, a robot, a machine, an artificial intelligence driven module, a human, etc.). For example, selection component 108 can select the quantum device having the highest level of fidelity or the lowest level of fidelity relative to other quantum device candidates. In some embodiments, selection component 108 can select a quantum device capable of executing a complex quantum program (e.g., a quantum program having deep quantum circuits).

In some embodiments, selection component 108 can select a quantum device that can execute a certain quantum program within a defined execution time (e.g., defined by an entity such as, for instance, a programmer, a device, a computer, a robot, a machine, an artificial intelligence driven module, a human, etc.).

In some embodiments, selection component 108 can select a quantum device based on software entitlement (e.g., user rights and/or user privileges such as, for instance, software licenses enabling access to quantum-based and/or classical software to execute the quantum program). For example, selection component 108 can select a quantum device that can execute a quantum program using quantum-based and/or classical software that require (or in some embodiments, that do not require) a software license to use.

In some embodiments, selection component 108 can select a quantum device that can execute a certain quantum program based on one or more entity preferences. For example, selection component 108 can select the quantum device that can execute the quantum program in the shortest amount of time relative to other quantum device candidates. In another example, selection component 108 can select the quantum device that can produce the most accurate computation results relative to other quantum device candidates.

In some embodiments, selection component 108 can select a quantum device that can execute a pulse schedule defined by, for instance, an entity (e.g., a programmer, a device, a computer, a robot, a machine, an artificial intelligence driven module, a human, etc.) that submitted the quantum program to quantum adaptive compilation system 102. For example, selection component 108 can select a quantum device that can execute a certain pulse schedule and/or certain pulse shapes (also referred to as pulse definitions) defined by such an entity (e.g., where one or more attributes of a pulse shape such as, for instance, shape, amplitude, length, etc. can be defined by such an entity).

In some embodiments, to facilitate selection of a quantum device that can execute a quantum program based on the one or more run criteria defined above, selection component 108 can further analyze one or more attributes of one or more quantum devices (e.g., to determine which is most suitable to execute the quantum program). For example, selection component 108 can analyze one or more attributes of one or more quantum devices including, but not limited to, a configuration of a quantum device, a property of a quantum device, a pulse library of a quantum device (e.g., a collection of default pulses that can be defined, calibrated, and/or periodically recalibrated to perform one or more certain operations on a certain quantum device); and/or another attribute of one or more quantum devices. In some embodiments, such a configuration and/or property of a quantum device can comprise information corresponding to the quantum device including, but not limited to: a quantum device specification; one or more control parameters of the quantum device (e.g., time-step set by control hardware (e.g., unit of time on hardware pulses), measurement time, and/or buffer time (e.g., time in between pulses when converting from a quantum assembly language (qasm) model to a pulse model); one or more select parameters (e.g., return values) about the quantum device that provide the pulses the quantum device supports; the time scales the quantum device supports; data about how the pulses are arranged (e.g., pulses of a quantum device pulse library); how many channels are allowed by the quantum device; and/or other information.

According to multiple embodiments, adaptive compilation component 110 can modify a quantum program based on one or more attributes of a quantum device to generate a modified quantum program compilation of the quantum program. For example, adaptive compilation component 110 can comprise a compiler (e.g., a source-to-source compiler, a transpiler, cross-compiler, bootstrap compiler, decompiler, etc.) that can modify a quantum program (e.g., a sequence of instructions comprising a collection of quantum circuits that can be executed on a quantum computer) based on the one or more attributes defined above that correspond to a quantum device that can be selected by selection component 108. For instance, adaptive compilation component 110 can comprise such a compiler defined above that can modify a quantum program based on one or more attributes of a quantum device including, but not limited to, a configuration of a quantum device, a property of a quantum device, a pulse library of a quantum device; and/or another attribute of a quantum device. In some embodiments, adaptive compilation component 110 can modify a quantum program based on the one or more attributes defined above that correspond to a quantum device selected by selection component 108 to generate a modified quantum program compilation of the quantum program that can run on such a quantum device selected by selection component 108.

In some embodiments, adaptive compilation component 110 can modify a quantum program by modifying one or more elements of such a quantum program including, but not limited to, a quantum circuit of a quantum program, a pulse schedule of a quantum program, and/or another element of the quantum program. For example, adaptive compilation component 110 can modify one or more features and/or parameters of a quantum circuit including, but not limited to, circuit topology (e.g., architecture) of the quantum circuit, quantity of qubits in the quantum circuit, frequency at which one or more qubits in the quantum circuit operate, one or more gates in the quantum circuit, and/or another feature and/or parameter of a quantum circuit. In another example, adaptive compilation component 110 can modify (e.g., via a pulse generator, a quantum pulse generator, etc.) one or more features and/or parameters of a pulse schedule including, but not limited to, pulse shape, pulse amplitude, pulse length, pulse timing, and/or another feature and/or parameter of a pulse schedule.

In some embodiments, adaptive compilation component 110 can comprise a compiler (e.g., a source-to-source compiler, a transpiler, cross-compiler, bootstrap compiler, decompiler, etc.) that can modify a quantum program by translating computer code written in a first programming language (also referred to as the source language) into a second programming language (also referred to as the target language). For example, adaptive compilation component 110 can comprise a compiler as defined above that can modify a quantum program by translating source code from, for instance, a first high-level programming language (e.g., python, a quantum assembly language (qasm) model, a pulse model, etc.) to, for instance, a second high-level programming language (e.g., python, a quantum assembly language (qasm) model, a pulse model, etc.) to create a modified quantum program compilation that can be executed by a quantum device selected by selection component 108. In another example, adaptive compilation component 110 can comprise a compiler as defined above that can modify a quantum program by translating source code from, for instance, a high-level programming language to, for instance, a lower level language (e.g., object code, machine code, assembly language, etc.) to create a modified quantum program compilation that can be executed by a quantum device selected by selection component 108.

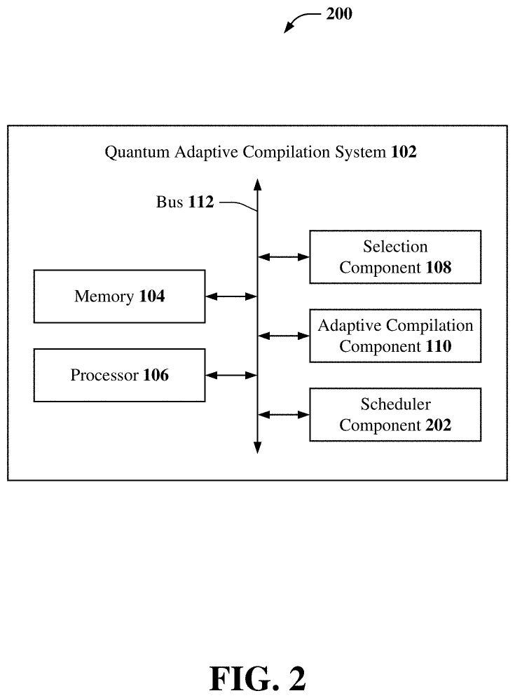

In some embodiments, adaptive compilation component 110 can dispatch a modified quantum program compilation to a queue of a quantum device to execute the modified quantum program compilation. For example, adaptive compilation component 110 can dispatch such a modified quantum program compilation described above to a queue of a quantum device selected by selection component 108. In some embodiments, adaptive compilation component 110 can dispatch a modified quantum program compilation to a queue of a quantum device to execute the modified quantum program compilation based on a run order position of the modified quantum program compilation in the queue of the quantum device. For example, adaptive compilation component 110 can dispatch such a modified quantum program compilation described above to a queue of a quantum device selected by selection component 108 to execute the modified quantum program compilation based on a run order position of the modified quantum program compilation in the queue of the quantum device, where such a run order position of the modified quantum program compilation can be determined by scheduler component 202 as described below with reference to FIG. 2.

In some embodiments, adaptive compilation component 110 can adjust one or more parameters of a quantum program to allow a compilation layer of a computing environment (e.g., a cloud computing environment such as, for instance, cloud computing environment 950 and/or one or more functional abstraction layers described below with reference to FIGS. 9 and 10, respectively) to compile one or more quantum circuits of the quantum program in a desired manner (e.g., in a manner that enables execution of such quantum circuit(s) by the next available quantum device). In some embodiments, adaptive compilation component 110 can comprise a service component that can consume (e.g., ingest, process, evaluate, etc.) one or more quantum circuits of a quantum program and depending on the status of a certain backend (e.g., workload status of a quantum device) and/or circuit characteristic (e.g., of the backend and/or of the quantum program), adaptive compilation component 110 can automatically (e.g., with assistance from a human) scale to generate one or more compilations (e.g., transpilations, etc.), one or more modified quantum circuits and/or one or more modified pulse generations (e.g., pulse(s), pulse schedule(s), etc.) to facilitate execution of such compilation(s), modified quantum circuit(s), and/or modified pulse generation(s) by a certain quantum device.

FIG. 2 illustrates a block diagram of an example, non-limiting system 200 that can facilitate adaptive compilation of quantum computing jobs in accordance with one or more embodiments described herein. In some embodiments, system 200 can comprise a quantum adaptive compilation system 102. In some embodiments, quantum adaptive compilation system 102 can comprise a scheduler component 202. Repetitive description of like elements and/or processes employed in various embodiments described herein is omitted for sake of brevity.

According to multiple embodiments, scheduler component 202 can determine a run order position of a modified quantum program compilation in a queue of a quantum device based on one or more run criteria. For example, scheduler component 202 can assign a run order position to a modified quantum program compilation (e.g., a modified quantum program compilation that can be generated by adaptive compilation component 110 as described above with reference to FIG. 1) in a queue of a quantum device (e.g., a quantum device that can be selected by selection component 108 as described above with reference to FIG. 1) based on such one or more run criteria defined above with reference to FIG. 1.

In some embodiments, scheduler component 202 can assign such a run order position to a modified quantum program compilation by assigning run order positions to all quantum computing jobs (e.g., pending quantum computing run instances to be executed) in a queue of a quantum device based on the one or more run criteria defined above. For example, scheduler component 202 can assign such a run order position to a modified quantum program compilation (e.g., a modified quantum program compilation that can be generated by adaptive compilation component 110 as described above with reference to FIG. 1) by assigning run order positions to all quantum computing jobs (e.g., pending quantum computing run instances to be executed) in a queue of a quantum device (e.g., a quantum device that can be selected by selection component 108 as described above with reference to FIG. 1) based on the one or more run criteria defined above. In some embodiments, scheduler component 202 can thereby generate a run order of all quantum computing jobs (e.g., pending quantum computing run instances to be executed) in a queue of such a quantum device that can be executed by the quantum device. In some embodiments, such a run order can comprise a run schedule comprising references to and/or descriptions of quantum computing jobs (e.g., pending quantum computing run instances to be executed), where such a run schedule can indicate when each quantum computing job (e.g., a modified quantum program compilation that can be generated by adaptive compilation component 110 as described above with reference to FIG. 1) can be executed by the quantum device. In some embodiments, such quantum computing jobs (e.g., a modified quantum program compilation that can be generated by adaptive compilation component 110 as described above with reference to FIG. 1) can comprise quantum computing run instances including, but not limited to, computations, data processing, and/or another quantum computing run instance.

In some embodiments, scheduler component 202 can generate such a run order of quantum computing jobs described above based on the one or more run criteria defined above by scheduling (e.g., co-scheduling) such quantum computing jobs using one or more bin packing algorithms. For example, scheduler component 202 can employ one or more bin packing algorithms including, but not limited to, one-dimensional (1D) bin packing algorithm, two-dimensional (2D) bin packing algorithm, three-dimensional (3D) bin packing algorithm, best-fit algorithm, first-fit algorithm, best-fit decreasing algorithm, first-fit decreasing algorithm, and/or another bin packing algorithm.

In some embodiments, scheduler component 202 can generate such a run order of computing jobs described above based on the one or more run criteria defined above by employing one or more bin packing algorithms defined above to schedule the quantum computing jobs such that they fit into the smallest number of iterations (e.g., execution cycles). For example, given a quantum device comprising a certain number of qubits (e.g., 8 qubits), scheduler component 202 can schedule (e.g., co-schedule) a certain number of quantum computing jobs (e.g., 2 jobs) per iteration, where each job requires a certain number of qubits (e.g., 4 qubits) and the total number of qubits required by all such quantum computing jobs does not exceed the number of qubits of the quantum device.

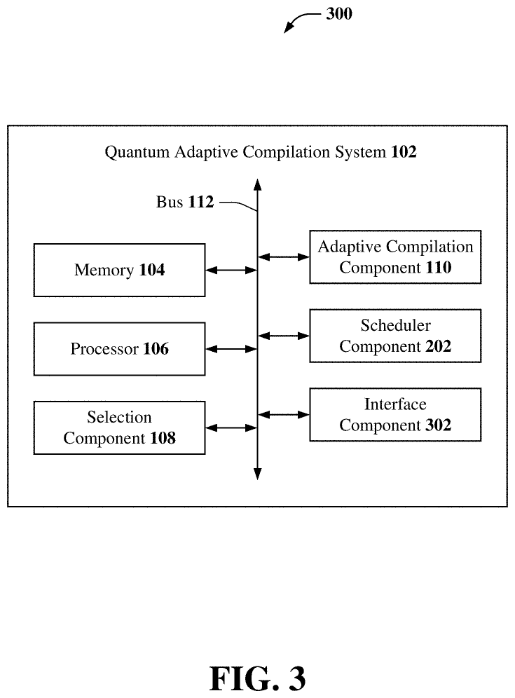

FIG. 3 illustrates a block diagram of an example, non-limiting system 300 that can facilitate adaptive compilation of quantum computing jobs in accordance with one or more embodiments described herein. In some embodiments, system 300 can comprise a quantum adaptive compilation system 102. In some embodiments, quantum adaptive compilation system 102 can comprise an interface component 302. Repetitive description of like elements and/or processes employed in various embodiments described herein is omitted for sake of brevity.

According to multiple embodiments, interface component 302 can comprise an application programming interface (API) that can enable an entity (e.g., a programmer, a device, a computer, a robot, a machine, an artificial intelligence driven module, a human, etc.) to submit a quantum program to and/or communicate with quantum adaptive compilation system 102. For example, interface component 302 can comprise an API that can comprise a microservice component in an online platform (e.g., cloud computing environment 950 and/or one or more functional abstraction layers described below with reference to FIGS. 9 and 10, respectively) that can enable such an entity submit the quantum program to and/or communicate with quantum adaptive compilation system 102.

In some embodiments, interface component 302 can comprise such an API defined above that can send a quantum program submitted by such an entity defined above to one or more components of quantum adaptive compilation system 102 (e.g., selection component 108, adaptive compilation component 110, etc.) for further processing before such a quantum program is executed by a quantum device. In some embodiments, interface component 302 can comprise such an API defined above that can manage the results of a quantum program executed by a quantum device (e.g., a modified quantum program compilation generated by adaptive compilation component 110 and executed by a quantum device selected by selection component 108 as described above with reference to FIG. 1). For example, interface component 302 can comprise such an API defined above that can return to such an entity defined above the results (e.g., in a certain format) of a modified quantum program compilation generated by adaptive compilation component 110 and executed by a quantum device selected by selection component 108. In another example, interface component 302 can comprise such an API defined above that can store in a memory device (e.g., memory 104) the results (e.g., in a certain format) of a modified quantum program compilation generated by adaptive compilation component 110 and executed by a quantum device selected by selection component 108.

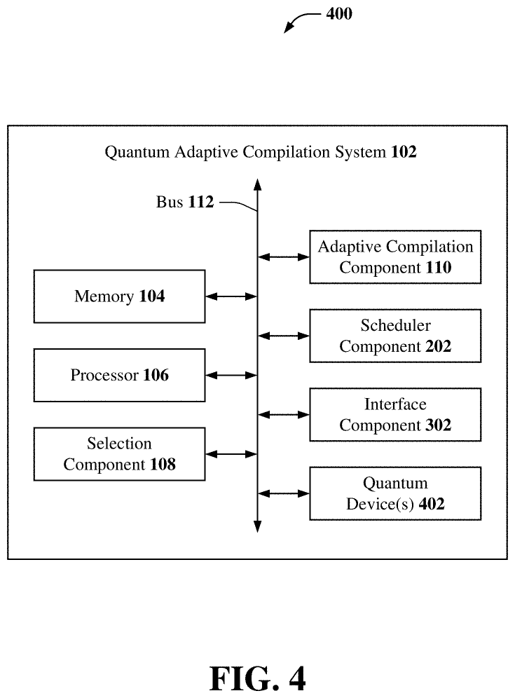

FIG. 4 illustrates a block diagram of an example, non-limiting system 400 that can facilitate adaptive compilation of quantum computing jobs in accordance with one or more embodiments described herein. In some embodiments, system 400 can comprise a quantum adaptive compilation system 102. In some embodiments, quantum adaptive compilation system 102 can comprise one or more quantum devices 402. Repetitive description of like elements and/or processes employed in various embodiments described herein is omitted for sake of brevity.

According to multiple embodiments, quantum device(s) 402 can comprise one or more quantum devices including, but not limited to, a quantum computer, a quantum processor, a quantum simulator, quantum hardware, a quantum chip (e.g., a superconducting circuit fabricated on a semiconducting device), one or more qubits of a quantum chip, and/or another quantum device. In some embodiments, one or more quantum devices 402 can be selected by selection component 108 as described above with reference to FIG. 1 to execute one or more quantum programs. For example, one or more quantum devices 402 can be selected by selection component 108 to execute a modified quantum program compilation that can be generated by adaptive compilation component 110 as described above with reference to FIG. 1. For instance, one or more quantum devices 402 can be selected by selection component 108 to execute such a modified quantum program compilation based on a run order that can be determined (e.g., assigned, defined, etc.) by scheduler component 202 as described above with reference to FIG. 2.

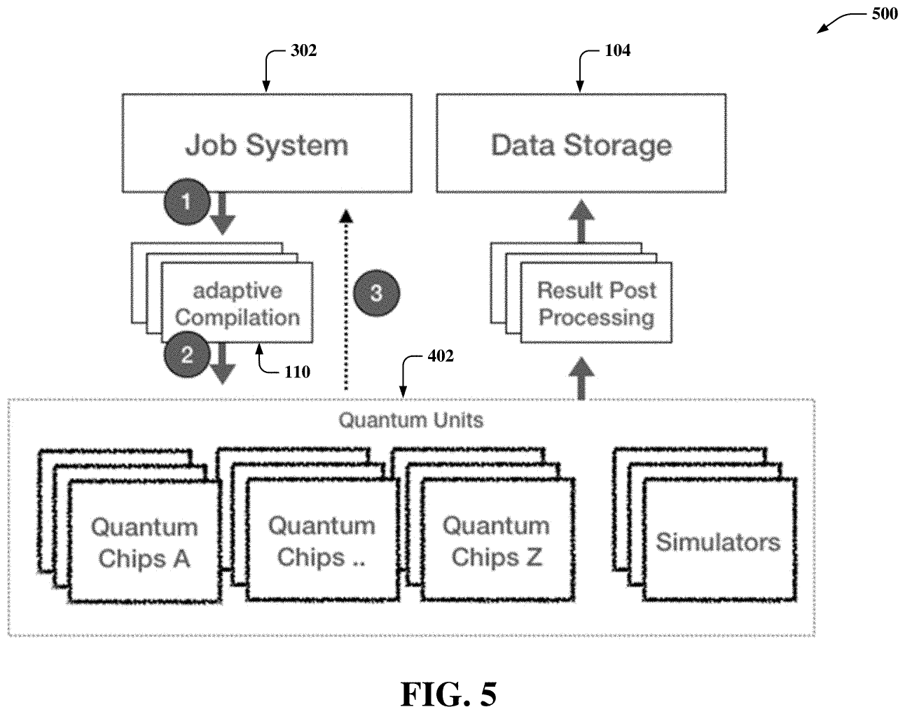

FIG. 5 illustrates a diagram of an example, non-limiting system 500 that can facilitate adaptive compilation of quantum computing jobs in accordance with one or more embodiments described herein. Repetitive description of like elements and/or processes employed in various embodiments described herein is omitted for sake of brevity.

According to multiple embodiments, system 500 can comprise an example, non-limiting alternative embodiment of system 400. In some embodiments, system 500 can comprise interface component 302 (denoted as Job System in FIG. 5) that can receive a quantum program from an entity (e.g., a programmer, a device, a computer, a robot, a machine, an artificial intelligence driven module, a human, etc.). In some embodiments, interface component 302 can send such a quantum program to adaptive compilation component 110 (denoted as adaptive Compilation in FIG. 5) to generate a modified quantum program compilation as described above with reference to FIG. 1. In some embodiments, selection component 108 can select a quantum device from quantum device(s) 402 (denoted as Quantum Units in FIG. 5) based on the one or more run criteria described above with reference to FIG. 1. In some embodiments, adaptive compilation component 110 can dispatch the modified quantum program compilation to a queue of the quantum device 402 selected by selection component 108 to execute the modified quantum program compilation based on a run order position of the modified quantum program compilation in such a queue, where such a run order position can be determined by scheduler component 202 as described above with reference to FIG. 2. In some embodiments, the quantum device selected by selection component 108 can execute the modified quantum program compilation generated by adaptive compilation component 110 and interface component 302 can manage the results of such execution. For example, interface component 302 can return the results to the entity that submitted the quantum program to interface component 302 and/or store such results in a memory device such as, for instance, memory 104 (denoted as Data Storage in FIG. 5).

In some embodiments, quantum adaptive compilation system 102 can be associated with various technologies. For example, quantum adaptive compilation system 102 can be associated with classical compiler technologies, quantum-based compiler technologies, classical computer workload scheduling technologies, quantum computer workload scheduling technologies, quantum mechanics technologies, quantum computation technologies, quantum computer technologies, quantum hardware and/or software technologies, quantum simulator technologies, classical domain and/or quantum domain data processing technologies, machine learning technologies, artificial intelligence technologies, and/or other technologies.

In some embodiments, quantum adaptive compilation system 102 can provide technical improvements to systems, devices, components, operational steps, and/or processing steps associated with the various technologies identified above. For example, quantum adaptive compilation system 102 can analyze one or more quantum devices (e.g., can analyze one or more attributes of each quantum device such as, for instance, configuration, properties, availability, etc.), as well as one or more quantum programs (e.g., the next quantum program(s)) waiting to run in such quantum devices(s) and can further modify one or more elements (e.g., quantum circuit(s), pulse schedule(s), etc.) of a certain quantum program to enable execution of such a quantum program on a certain quantum device at a particular moment (e.g., the next available quantum device, the quantum device having the highest level of fidelity relative to other quantum device, etc.). In this example, quantum adaptive compilation system 102 can: a) receive (e.g., via interface component 302) a quantum program; b) analyze the circuits to run and the backends (e.g., quantum devices) available; and/or c) generate a modified quantum program compilation (e.g., by modifying of one or more elements of the received quantum program) that can be ready to execute in the next iteration of an available backend. In this example, therefore, quantum adaptive compilation system 102 can facilitate reduced execution time of a certain quantum program submitted to quantum adaptive compilation system 102 and/or enable a balancing of the workloads of the quantum devices (e.g., reducing latency of the quantum devices) to stabilize the use of each one in function of the quantum programs submitted to quantum adaptive compilation system 102.

In some embodiments, quantum adaptive compilation system 102 can provide technical improvements to a processing unit (e.g., processor 106) associated with a classical computing device and/or a quantum computing device (e.g., a quantum processor, quantum hardware, superconducting circuit, etc.). For example, by performing compilation of (e.g., programming language translation) and/or modification of one or more elements of a received quantum program (e.g., quantum circuit(s), pulse schedule(s), etc.) to generate a modified quantum program compilation that can be executed by a certain quantum device at a certain time, quantum adaptive compilation system 102 can facilitate reduced execution time of a certain quantum program submitted to quantum adaptive compilation system 102 and/or reduced latency of the quantum device, thereby improving efficiency and/or performance of a processing unit (e.g., processor 106) associated with such a quantum device.

In some embodiments, quantum adaptive compilation system 102 can employ hardware or software to solve problems that are highly technical in nature, that are not abstract and that cannot be performed as a set of mental acts by a human In some embodiments, one or more of the processes described herein can be performed by one or more specialized computers (e.g., a specialized processing unit, a specialized classical computer, a specialized quantum computer, etc.) to execute defined tasks related to the various technologies identified above. In some embodiments, quantum adaptive compilation system 102 and/or components thereof, can be employed to solve new problems that arise through advancements in technologies mentioned above, employment of quantum computing systems, cloud computing systems, computer architecture, and/or another technology.

It is to be appreciated that quantum adaptive compilation system 102 can utilize various combinations of electrical components, mechanical components, and circuitry that cannot be replicated in the mind of a human or performed by a human, as the various operations that can be executed by quantum adaptive compilation system 102 and/or components thereof as described herein are operations that are greater than the capability of a human mind. For instance, the amount of data processed, the speed of processing such data, or the types of data processed by quantum adaptive compilation system 102 over a certain period of time can be greater, faster, or different than the amount, speed, or data type that can be processed by a human mind over the same period of time.

According to several embodiments, quantum adaptive compilation system 102 can also be fully operational towards performing one or more other functions (e.g., fully powered on, fully executed, etc.) while also performing the various operations described herein. It should be appreciated that such simultaneous multi-operational execution is beyond the capability of a human mind. It should also be appreciated that quantum adaptive compilation system 102 can include information that is impossible to obtain manually by an entity, such as a human user. For example, the type, amount, and/or variety of information included in quantum adaptive compilation system 102, selection component 108, adaptive compilation component 110, scheduler component 202, interface component 302, and/or quantum device(s) 402 can be more complex than information obtained manually by a human user.

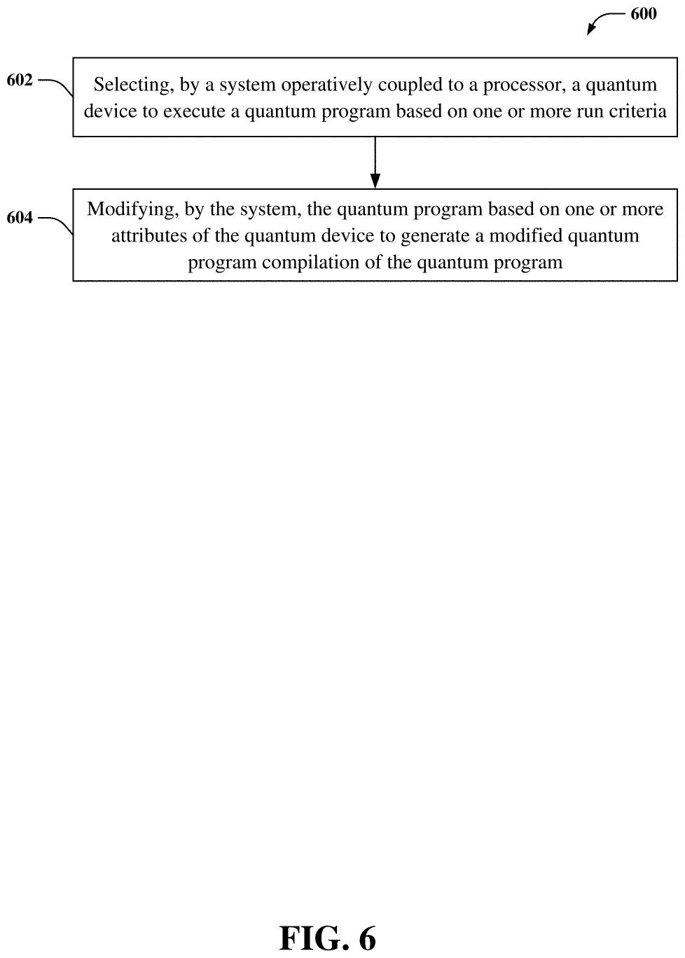

FIG. 6 illustrates a flow diagram of an example, non-limiting computer-implemented method 600 that can facilitate adaptive compilation of quantum computing jobs in accordance with one or more embodiments described herein. Repetitive description of like elements and/or processes employed in various embodiments described herein is omitted for sake of brevity.

In some embodiments, at 602, computer-implemented method 600 can comprise selecting, by a system (e.g., via quantum adaptive compilation system 102 and/or selection component 108) operatively coupled to a processor (e.g., processor 106), a quantum device (e.g., one of quantum device(s) 402) to execute a quantum program (e.g., a quantum program submitted to interface component 302 as described above with reference to FIG. 3 and/or a modified quantum program compilation that can be generated by adaptive compilation component 110 as described above with reference to FIG. 1) based on one or more run criteria. In some embodiments, such one or more run criteria can comprise quantum-based run criteria associated with executing processing workloads using a quantum device (e.g., quantum computer, quantum processor, quantum simulator, etc.). In some embodiments, selection component 108 can select a quantum device (e.g., quantum computer, quantum processor, quantum simulator, etc.) to execute a quantum program based on one or more run criteria (e.g., quantum-based run criteria) including, but not limited to: availability of the quantum device; access to the quantum device (e.g., user rights and/or user privileges enabling access to the quantum device by an entity requesting execution of the quantum program); workload of the quantum device; fidelity of the quantum device (e.g., fidelity of one or more qubits of the quantum device, accuracy of the results generated by the quantum device, etc.); complexity of the quantum program (e.g., complexity of one or more circuits of the quantum program, etc.); anticipated execution time corresponding to the quantum program; entity software entitlement (e.g., user rights and/or user privileges such as, for instance, software licenses enabling access to quantum-based and/or classical software to execute the quantum program); entity preference (e.g., preference of shorter execution time and potentially less accurate results, preference of longer execution time and potentially more accurate results, etc.); entity defined pulse schedule; and/or another run criterion. In some embodiments, selection component 108 can select a quantum device to execute a quantum program based on such one or more run criteria defined above where such a quantum device can include, but is not limited to, a quantum computer, a quantum processor, a quantum simulator, and/or another quantum device.

In some embodiments, at 604, computer-implemented method 600 can comprise modifying, by the system (e.g., via quantum adaptive compilation system 102 and/or adaptive compilation component 110), the quantum program based on one or more attributes (e.g., configuration, properties, pulse library, availability, etc.) of the quantum device to generate a modified quantum program compilation of the quantum program. In some embodiments, adaptive compilation component 110 can modify such a quantum program by translating the quantum program from a first high-level programming language to a second high-level programming language and/or by modifying one or more elements (e.g., quantum circuit(s), pulse schedule(s), etc.) of the quantum program based on such one or more attributes of a certain quantum device to generate a modified quantum program compilation that can be executed by such a quantum device at a certain time (e.g., as determined by scheduler component 202).

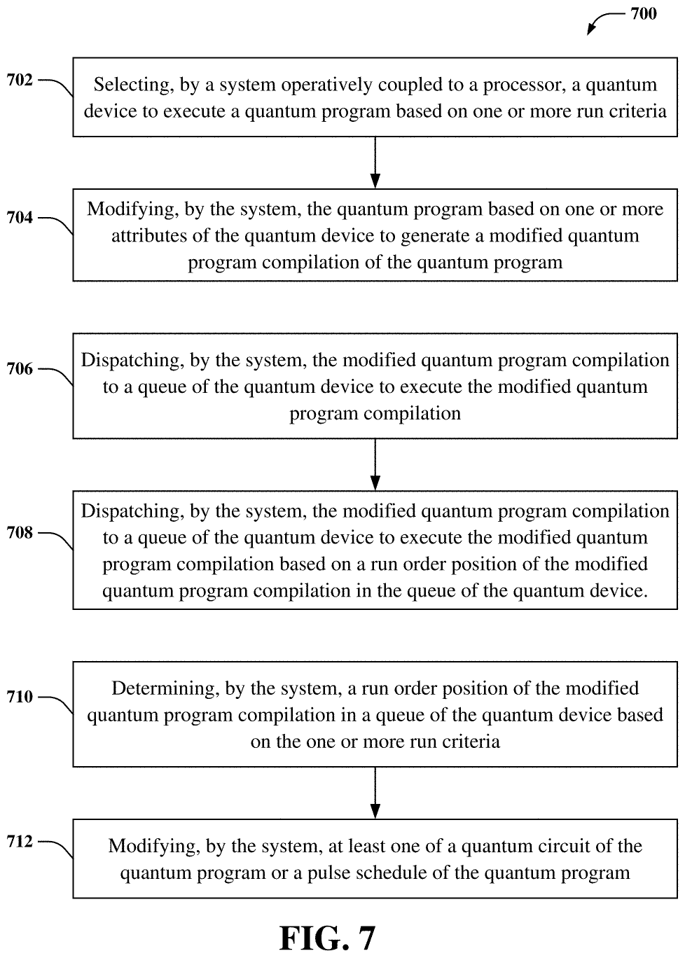

FIG. 7 illustrates a flow diagram of an example, non-limiting computer-implemented method 700 that can facilitate adaptive compilation of quantum computing jobs in accordance with one or more embodiments described herein. Repetitive description of like elements and/or processes employed in various embodiments described herein is omitted for sake of brevity.

In some embodiments, at 702, computer-implemented method 700 can comprise selecting, by a system (e.g., via quantum adaptive compilation system 102 and/or selection component 108) operatively coupled to a processor (e.g., processor 106), a quantum device (e.g., one of quantum device(s) 402) to execute a quantum program (e.g., a quantum program submitted to interface component 302 as described above with reference to FIG. 3 and/or a modified quantum program compilation that can be generated by adaptive compilation component 110 as described above with reference to FIG. 1) based on one or more run criteria. In some embodiments, such one or more run criteria can comprise quantum-based run criteria associated with executing processing workloads using a quantum device (e.g., quantum computer, quantum processor, quantum simulator, etc.). In some embodiments, selection component 108 can select a quantum device (e.g., quantum computer, quantum processor, quantum simulator, etc.) to execute a quantum program based on one or more run criteria (e.g., quantum-based run criteria) including, but not limited to: availability of the quantum device; access to the quantum device (e.g., user rights and/or user privileges enabling access to the quantum device by an entity requesting execution of the quantum program); workload of the quantum device; fidelity of the quantum device (e.g., fidelity of one or more qubits of the quantum device, accuracy of the results generated by the quantum device, etc.); complexity of the quantum program (e.g., complexity of one or more circuits of the quantum program, etc.); anticipated execution time corresponding to the quantum program; entity software entitlement (e.g., user rights and/or user privileges such as, for instance, software licenses enabling access to quantum-based and/or classical software to execute the quantum program); entity preference (e.g., preference of shorter execution time and potentially less accurate results, preference of longer execution time and potentially more accurate results, etc.); entity defined pulse schedule; and/or another run criterion. In some embodiments, selection component 108 can select a quantum device to execute a quantum program based on such one or more run criteria defined above where such a quantum device can include, but is not limited to, a quantum computer, a quantum processor, a quantum simulator, and/or another quantum device.

In some embodiments, at 704, computer-implemented method 700 can comprise modifying, by the system (e.g., via quantum adaptive compilation system 102 and/or adaptive compilation component 110), the quantum program based on one or more attributes (e.g., configuration, properties, pulse library, availability, etc.) of the quantum device to generate a modified quantum program compilation of the quantum program. In some embodiments, adaptive compilation component 110 can modify such a quantum program by translating the quantum program from a first high-level programming language to a second high-level programming language and/or by modifying one or more elements (e.g., quantum circuit(s), pulse schedule(s), etc.) of the quantum program based on such one or more attributes of a certain quantum device to generate a modified quantum program compilation that can be executed by such a quantum device at a certain time (e.g., as determined by scheduler component 202).

In some embodiments, at 706, computer-implemented method 700 can comprise dispatching, by the system (e.g., via quantum adaptive compilation system 102 and/or adaptive compilation component 110), the modified quantum program compilation to a queue of the quantum device to execute the modified quantum program compilation.

In some embodiments, at 708, computer-implemented method 700 can comprise dispatching, by the system (e.g., via quantum adaptive compilation system 102 and/or adaptive compilation component 110), the modified quantum program compilation to a queue of the quantum device to execute the modified quantum program compilation based on a run order position of the modified quantum program compilation in the queue of the quantum device (e.g., where such a run order position can be determined by scheduler component 202 as described above with reference to FIG. 2).

In some embodiments, at 710, computer-implemented method 700 can comprise determining, by the system (e.g., via quantum adaptive compilation system 102 and/or scheduler component 202), a run order position of the modified quantum program compilation in a queue of the quantum device based on the one or more run criteria.

In some embodiments, at 712, computer-implemented method 700 can comprise modifying, by the system (e.g., via quantum adaptive compilation system 102 and/or adaptive compilation component 110), at least one of a quantum circuit of the quantum program or a pulse schedule of the quantum program (e.g., via a pulse generator, a quantum pulse generator, etc.).

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

In order to provide a context for the various aspects of the disclosed subject matter, FIG. 8 as well as the following discussion are intended to provide a general description of a suitable environment in which the various aspects of the disclosed subject matter can be implemented. FIG. 8 illustrates a block diagram of an example, non-limiting operating environment in which one or more embodiments described herein can be facilitated. Repetitive description of like elements employed in other embodiments described herein is omitted for sake of brevity.

With reference to FIG. 8, a suitable operating environment 800 for implementing various aspects of this disclosure can also include a computer 812. The computer 812 can also include a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814. The system bus 818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 816 can also include volatile memory 820 and nonvolatile memory 822. The basic input/output system (BIOS), containing the basic routines to transfer information between elements within the computer 812, such as during start-up, is stored in nonvolatile memory 822. Computer 812 can also include removable/non-removable, volatile/non-volatile computer storage media. FIG. 8 illustrates, for example, a disk storage 824. Disk storage 824 can also include, but is not limited to, devices like a magnetic disk drive, floppy disk drive, tape drive, Jaz drive, Zip drive, LS-100 drive, flash memory card, or memory stick. The disk storage 824 also can include storage media separately or in combination with other storage media. To facilitate connection of the disk storage 824 to the system bus 818, a removable or non-removable interface is typically used, such as interface 826. FIG. 8 also depicts software that acts as an intermediary between users and the basic computer resources described in the suitable operating environment 800. Such software can also include, for example, an operating system 828. Operating system 828, which can be stored on disk storage 824, acts to control and allocate resources of the computer 812.

System applications 830 take advantage of the management of resources by operating system 828 through program modules 832 and program data 834, e.g., stored either in system memory 816 or on disk storage 824. It is to be appreciated that this disclosure can be implemented with various operating systems or combinations of operating systems. A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port can be used to provide input to computer 812, and to output information from computer 812 to an output device 840. Output adapter 842 is provided to illustrate that there are some output devices 840 like monitors, speakers, and printers, among other output devices 840, which require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a computer, a server, a router, a network PC, a workstation, a microprocessor based appliance, a peer device or other common network node and the like, and typically can also include many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 850 refers to the hardware/software employed to connect the network interface 848 to the system bus 818. While communication connection 850 is shown for illustrative clarity inside computer 812, it can also be external to computer 812. The hardware/software for connection to the network interface 848 can also include, for exemplary purposes only, internal and external technologies such as, modems including regular telephone grade modems, cable modems and DSL modems, ISDN adapters, and Ethernet cards.

Referring now to FIG. 9, an illustrative cloud computing environment 950 is depicted. As shown, cloud computing environment 950 includes one or more cloud computing nodes 910 with which local computing devices used by cloud consumers, such as, for example, personal digital assistant (PDA) or cellular telephone 954A, desktop computer 954B, laptop computer 954C, and/or automobile computer system 954N may communicate. Nodes 910 may communicate with one another. They may be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that computing nodes 910 and cloud computing environment 950 can communicate with any type of computerized device over any type of network and/or network addressable connection (e.g., using a web browser).

Referring now to FIG. 10, a set of functional abstraction layers provided by cloud computing environment 950 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066. In some embodiments, software components include network application server software 1067 and database software 1068.

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and Pricing 1082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Non-limiting examples of workloads and functions which may be provided from this layer include: mapping and navigation 1091; software development and lifecycle management 1092; virtual classroom education delivery 1093; data analytics processing 1094; transaction processing 1095; and quantum adaptive compilation software 1096.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
a selection component that selects a quantum device to execute a quantum program based on one or more run criteria; and
an adaptive compilation component that modifies the quantum program based on one or more attributes of the quantum device to generate a modified quantum program compilation of the quantum program.

2. The system of claim 1, wherein the adaptive compilation component further dispatches the modified quantum program compilation to a queue of the quantum device to execute the modified quantum program compilation, thereby facilitating at least one of reduced turnaround time to execute the quantum program or reduced latency of the quantum device.

3. The system of claim 1, wherein the adaptive compilation component further dispatches the modified quantum program compilation to a queue of the quantum device to execute the modified quantum program compilation based on a run order position of the modified quantum program compilation in the queue of the quantum device.

4. The system of claim 1, wherein the computer executable components further comprise:
a scheduler component that determines a run order position of the modified quantum program compilation in a queue of the quantum device based on the one or more run criteria.

5. The system of claim 1, wherein the adaptive compilation component modifies at least one of a quantum circuit of the quantum program or a pulse schedule of the quantum program.

6. The system of claim 1, wherein the one or more attributes of the quantum device are selected from a group consisting of a configuration of the quantum device and a property of the quantum device.

7. The system of claim 1, wherein the one or more run criteria are selected from a group consisting of: availability of the quantum device; access to the quantum device; workload of the quantum device; fidelity of the quantum device; complexity of the quantum program; anticipated execution time corresponding to the quantum program; entity software entitlement; entity preference; and entity defined pulse schedule.

8. A computer-implemented method, comprising:
selecting, by a system operatively coupled to a processor, a quantum device to execute a quantum program based on one or more run criteria; and
modifying, by the system, the quantum program based on one or more attributes of the quantum device to generate a modified quantum program compilation of the quantum program.

9. The computer-implemented method of claim 8, further comprising:
dispatching, by the system, the modified quantum program compilation to a queue of the quantum device to execute the modified quantum program compilation, thereby facilitating at least one of reduced turnaround time to execute the quantum program or reduced latency of the quantum device.

10. The computer-implemented method of claim 8, further comprising:
dispatching, by the system, the modified quantum program compilation to a queue of the quantum device to execute the modified quantum program compilation based on a run order position of the modified quantum program compilation in the queue of the quantum device.

11. The computer-implemented method of claim 8, further comprising:
determining, by the system, a run order position of the modified quantum program compilation in a queue of the quantum device based on the one or more run criteria.

12. The computer-implemented method of claim 8, wherein the modifying comprises:
modifying, by the system, at least one of a quantum circuit of the quantum program or a pulse schedule of the quantum program.

13. The computer-implemented method of claim 8, wherein the one or more attributes of the quantum device are selected from a group consisting of a configuration of the quantum device and a property of the quantum device.

14. The computer-implemented method of claim 8, wherein the one or more run criteria are selected from a group consisting of: availability of the quantum device; access to the quantum device; workload of the quantum device; fidelity of the quantum device; complexity of the quantum program; anticipated execution time corresponding to the quantum program; entity software entitlement; entity preference; and entity defined pulse schedule.

15. A computer program product facilitating an adaptive compilation of quantum computing jobs process, the computer program product comprising a computer readable storage medium having program instructions embodied therewith, the program instructions executable by a processor to cause the processor to:
select, by the processor, a quantum device to execute a quantum program based on one or more run criteria; and
modify, by the processor, the quantum program based on one or more attributes of the quantum device to generate a modified quantum program compilation of the quantum program.

16. The computer program product of claim 15, wherein the program instructions are further executable by the processor to cause the processor to:
dispatch, by the processor, the modified quantum program compilation to a queue of the quantum device to execute the modified quantum program compilation.

17. The computer program product of claim 15, wherein the program instructions are further executable by the processor to cause the processor to:
dispatch, by the processor, the modified quantum program compilation to a queue of the quantum device to execute the modified quantum program compilation based on a run order position of the modified quantum program compilation in the queue of the quantum device.

18. The computer program product of claim 15, wherein the program instructions are further executable by the processor to cause the processor to:
determine, by the processor, a run order position of the modified quantum program compilation in a queue of the quantum device based on the one or more run criteria.

19. The computer program product of claim 15, wherein the program instructions are further executable by the processor to cause the processor to:
modify, by the processor, at least one of a quantum circuit of the quantum program or a pulse schedule of the quantum program.

20. The computer program product of claim 15, wherein the one or more attributes of the quantum device are selected from a first group consisting of a configuration of the quantum device and a property of the quantum device, and wherein the one or more run criteria are selected from a second group consisting of: availability of the quantum device; access to the quantum device; workload of the quantum device; fidelity of the quantum device; complexity of the quantum program; anticipated execution time corresponding to the quantum program; entity software entitlement; entity preference; and entity defined pulse schedule.
